(19) United States
(12) Patent Application Publication
(10) Pub. No.: US 2020/0354942 A1
(43) Pub. Date: Nov. 12, 2020

(54) TELESCOPING OUTFALL SYSTEM FOR A RESERVOIR

(71) Applicant: John Collins, Osteen, FL (US)

(72) Inventor: John Collins, Osteen, FL (US)

(21) Appl. No.: 16/407,259

(22) Filed: May 9, 2019

(51) Int. Cl. E03F 5/10

(52) U.S. Cl. CPC E03F 5/101; C02F 2103/001; E03F 5/105

(57) ABSTRACT

A reservoir withdrawal system is disclosed comprising a selectively-adjustable water intake positioned within a reservoir. The water intake is adapted to withdraw water from the reservoir at a desired depth using a telescoping conduit. A water transport system is in fluid communication with the water intake and with a water discharge. A controller allows an operator to selectively adjust the desired depth of the water intake.

### TECHNICAL FIELD

The embodiments generally relate to environmental technologies, and more specifically, relate to outfall pipes to manage stormwater flow.

### BACKGROUND

Stormwater runoff is collected in a retention basin to prevent flooding of surrounding areas, to prevent erosion, and to improve water quality in an adjacent waterway or body of water. In urban areas, impervious surfaces such as roadways reduce the time rainfall spends on the ground before entering the stormwater drainage system. If left unchecked, this can cause widespread flooding downstream. A retention basin allows for the collection of stormwater to contain the surge of effluent, which can be released slowly, thus mitigating the size and intensity of storm-induced flooding on downstream receiving waters.

The discharge of water from the retention basin is controlled by the outfall pipe which discharges the effluent to a body of water. The location, configuration, and size of the outfall pipe may have various environmental, public safety, and system performance impacts.

Many dams are constructed having a principal spillway designed as a siphoning system to draw down the water level when desired. The siphoning action is triggered by closing the vent and evacuating all air out of the system. If the vent remains closed, siphoning will continue until the discharge valve is manually shut or the water level reaches the depth of the intake and duction is lost. Maintaining the dam's freeboard through proper maintenance and operation of the principal spillway is essential to the long-term safety and lifespan of the dam. Extreme rainfall resulting in overtopping is one of the leading causes of catastrophic dam collapses.

A variation of the Bernoulli Equation determines the flow capacity of the siphon. The flow rate depends on the diameter of the siphon pipe, the elevation difference from the outfall outlet to the reservoir water surface level, the Manning's n value of the pipe material, the total length of the pipe, and the hydraulic losses associated with various siphon components (e.g, entrance grates, bends, valves, exits, etc.).

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide for a reservoir water withdrawal system comprising a selectively-adjustable water intake positioned within a reservoir. The water intake is adapted to withdraw water from the reservoir at a desired depth using a telescoping conduit. A water transport system is in fluid communication with the water intake and to a water discharge. A controller allows an operator to selectively adjust the desired depth of the water intake.

The embodiments allow for an operator to selectively withdraw water from the reservoir to promote the structural integrity of the water retainment system and facilitate the health of the surrounding environment and ecosystems. The telescoping conduit allows for the flow rate to be adjusted by the operator by selecting the depth of the water intake within the reservoir.

In one aspect, the water intake is comprised of a telescoping conduit. The telescoping conduit is selectively adjustable to regulate the rate of flow of water into the water intake.

In one aspect, the telescoping conduit is formed of a plurality of telescoping segments each comprised of an outer conduit and an inner conduit. The outer conduit is comprised of one or more rubber seals to seal water and air in the telescoping conduit.

In one aspect, the outer conduit rotates around an inner conduit.

In one aspect, an air vent is provided in the intake system to initiate a siphon to withdraw water from the reservoir. The size of the air vent is proportional to the size of the telescoping conduit diameter.

In one aspect, the water intake includes a filter element to remove contaminants from the water withdrawn from the reservoir.

In one aspect, the telescoping conduit permits an operator to regulate a plurality of water characteristics measurable by a sensor array disposed in the reservoir, in the outfall system, or the surrounding environment.

In one aspect, the plurality of water characteristics includes water flow rate, water temperature, water turbidity, and water microbiome.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an exemplary reservoir outfall system, according to some embodiments;

FIG. 2 illustrates a schematic of the telescoping outfall system, according to some embodiments;

FIG. 3 illustrates a schematic of the telescopic conduit and water withdraw system, according to some embodiments;

FIG. 4 illustrates a front elevation view of the telescoping conduit, according to some embodiments;

FIG. 5 illustrates a side elevation view of the outer conduit and seals, according to some embodiments;

FIG. 6 illustrates a block diagram of the reservoir control system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments described herein relate to an outfall system for use in dams, lakes, and stormwater retention or similar reservoir systems affected by rainfall. The outfall system function to maintain a safe water level within the reservoir to avoid overtopping, degradation, and critical failure of the reservoir system. The system allows for an operator to selectively withdraw water from the reservoir to ensure readiness before a storm, to selectively discharge water from a determined depth, so as to control, for example, the temperature of the withdrawn water, select for sedimentation, select for water quality, or transport aquatic biota. Similarly, desired changes in the downstream body of water may be modified using the system described herein.

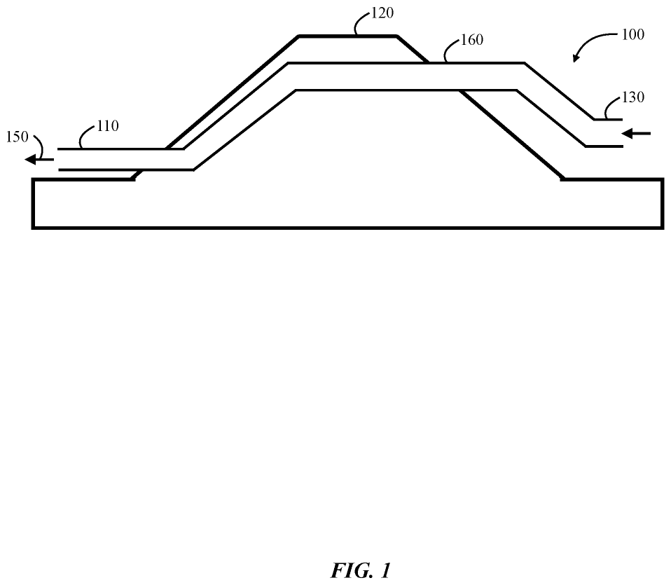

FIG. 1 illustrates an exemplary reservoir 100 having an outfall 110 to prevent the overtopping of the retainer 120 (i.e., a dam, barrier, levy, embankment, or similar natural or artificial structure) and therefore mitigate downstream flooding. An intake 130 is positioned within the reservoir 100 at a specified depth to permit the withdraw of water through the conduit to the outfall 110 to transmit the water into a downstream waterway 150. The outfall 110 provides a means for creating a siphon to draw water from the reservoir 100 through the intake 130 by hermetically sealing a vent 160. The siphon will continue to operate until the intake 130 and water level in the reservoir 100 are equalized, or until the vent 160 is opened. Other siphoning systems are contemplated including tube-in-tube systems known in the arts.

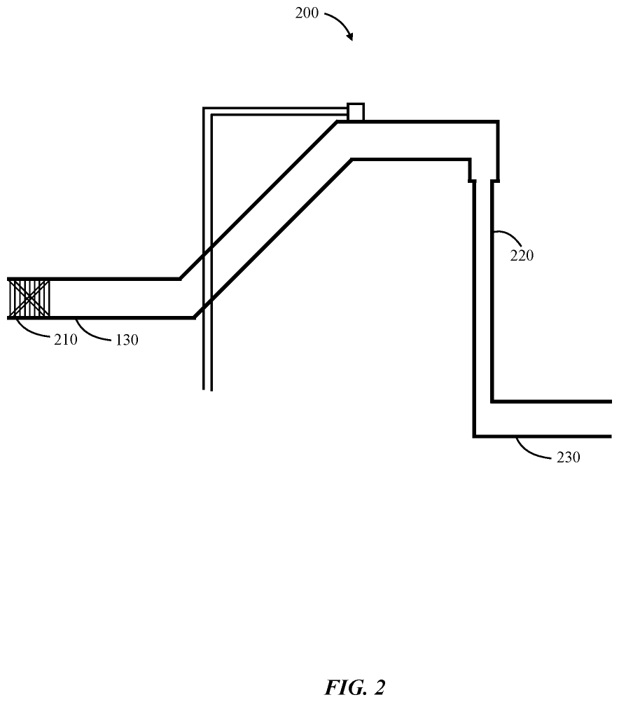

FIG. 2 illustrates a schematic of the telescoping outfall system 200 to permit the selective adjustment of the intake 130 positioned in the reservoir. The intake 130 may include a filter element 210, such as a screen to filter contaminants in the water. The water intake 130 depth in the reservoir is adjusted by a telescoping conduit 220 which may extend or retract to modulate the water intake 130 depth as well as modulate the water flow rate through the system 200. The outfall conduit 230 is dimensioned to prevent the telescoping conduit from submerging and thus retain an airgap to maintain siphoning action.

In some embodiments, the diameter of the water intake 130 is greater than the diameter of the telescoping conduit 220 (see FIG. 2) to allow for the selective initiation of the siphoning action.

The change in the height of the telescoping conduit will depend on the specific requirements of the reservoir and the outfall system associated thereto. In some embodiments, the telescoping conduit may extend greater than 20 feet.

The water intake conduit depicted is preferably rigid, primarily of metal, plastic, or composite, and of a diameter consistent with desired maximum flow. The conduit design uses gravity flow and may incorporate submersible pumps to facilitate water transport. In some embodiments, a hydraulic control system may be utilized. The embodiments may also incorporate multiple intake extensions, each able to target specific water layers in different locations and combine their loads for larger processing volumes. Telescoping conduit arrangements enable siphoning and custom control of water flow rates.

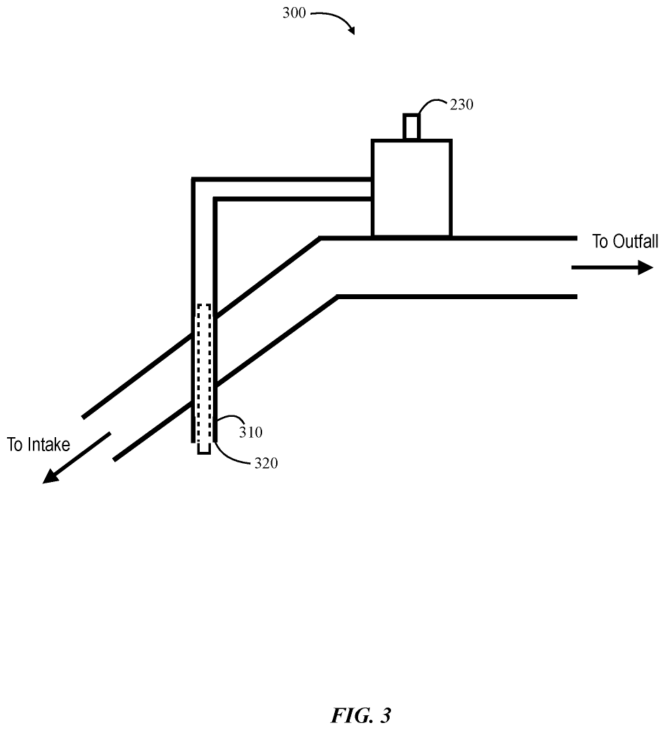

FIG. 3 illustrates a detail view of the air vent controlled telescoping outfall system 300 configured to allow for the selectable modulation of the water level in the reservoir. An air vent 310 is positioned at a bottom end of a second telescoping conduit 310. The air vent 320 is dimensioned proportional to the secondary telescoping conduit 310 diameters. A plug 330 is positioned at the top portion of the telescoping secondary telescoping conduit 310 to initiate the siphoning action.

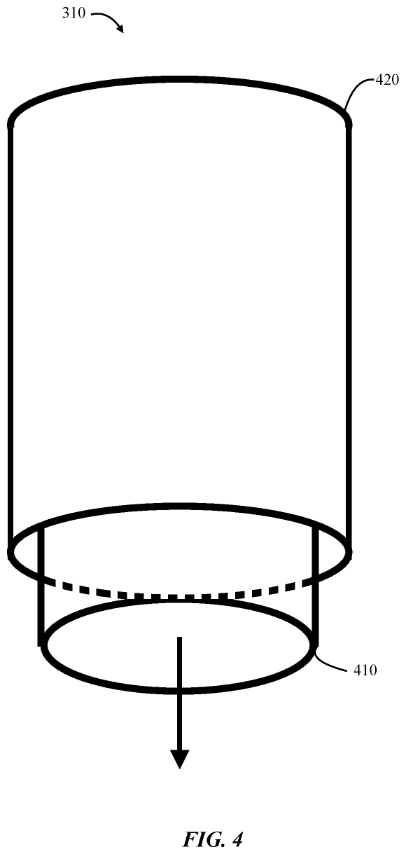

FIG. 4 illustrates a detailed view of the telescoping conduit 310 which is formed of a plurality of telescoping members allowing for the conduit to extend or retract in length to draw water from varying depths within the reservoir. In the illustrated embodiment, a first member 410 is dimensioned to slide within the interior of a second member 420 to extend or retract the total length of the telescoping conduit 310. The telescoping conduit 310 may be operated by a moving element in communication with a control module to permit an operator to select a depth to draw water from the reservoir by selecting a length of the telescoping conduit 310. In the illustrated embodiment, the second member 420 remains stationary, while the first member 410 telescopes within the second member 420 to modulate the length of the telescoping conduit 310.

The variable length of the telescoping conduit allows for variations in water surface height above the intake. In some embodiments, the telescoping conduit may be constructed of a semi-flexible material to accommodate normal water movement in the reservoir, as well as wind forces and earthquake movements. The embodiments may include any number of metallic or polymeric materials that would be suitable for the telescoping conduit, depending on the specific engineering requirements of a particular application of the system. Considerations in the choice of materials include weight, flexibility, water permeability, and durability.

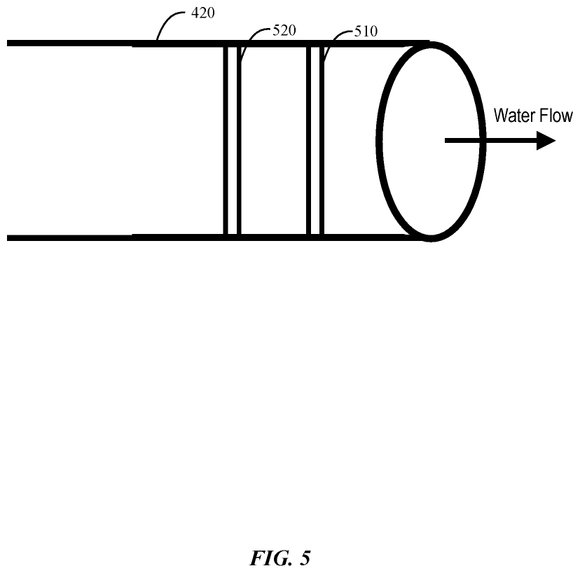

FIG. 5 illustrates a detailed view of the second member 420. To seal the second member 420 to the first member, seals 510,520 are positioned within a recessed channel formed in the surface of the second member 420. The seals may be constructed of rubber or similar material to hermetically seal water from the air within the system.

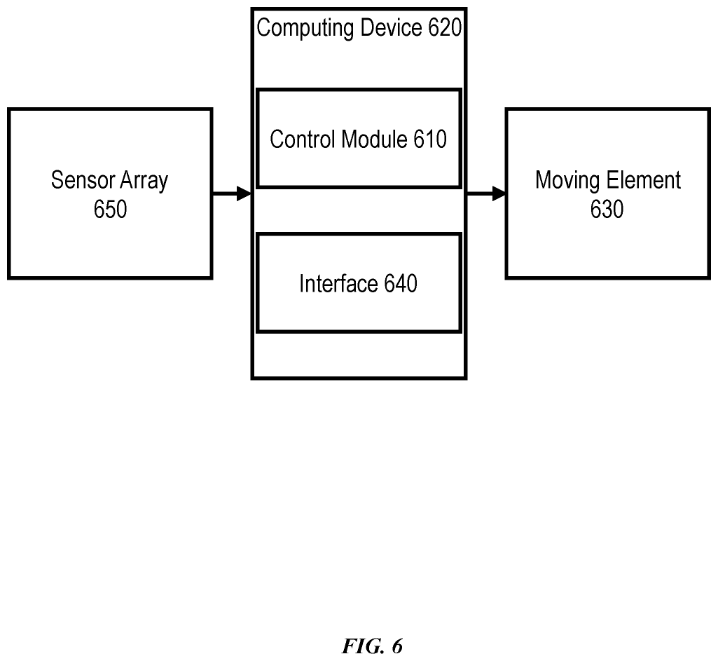

FIG. 6 illustrates a water level control system 600 to allow an operator to selectively control the water level, water flow rate, and characteristics of the water withdrawn from the reservoir. The water level control system 600 includes a control module 610 operatively connected to a computing device 620 to send an output signal to a moving element 630. The moving element 630 receives the output signal from the computing device 620, instructing the moving element to extend or retract the telescoping conduit, and in doing so, selectively changing the water withdrawal depth, the water flow rate, and water characteristics of the water transmitted through the system via an interface 640. A sensor array 650 includes a plurality of sensors positioned at the reservoir, within the outfall system, and/or in the surrounding environment (including the downstream ecosystem) to measure various metrics which may be changed by the telescoping conduit effected by the water level control system 600.

In some embodiments, the system may incorporate temperature sensors, pressure sensors, water flow rate sensors, and other sensors known in the arts to enable the system to make real-time adjustment in intake location based on output signals from the sensors. Sensors may include volumetric or mass flow rate sensors known in the arts. Each sensor is positioned at a suitable location to monitor the system. For example, a water flow rate sensor may be positioned at the intake, and another water flow rate sensor may be positioned at the outfall to measure water flow at various points in the outfall system. In another example, a pressure sensor may be disposed at the intake to determine the depth of the intake in real-time. The sensor array allows for water temperature, oxygenation, and turbidity conditions to be monitored and changed by the operator.

In some embodiments, the system also includes various warning and safety devices known in the arts.

Failure to change downstream river characteristics may result in damage to the environment, additional difficulty in the restoration of native fisheries, continued difficulties with the body of water's health, loss of recreation potential, negative impact on local economies, and loss of power production. Therefore, additional uses of the system are aquatic biota passage and influencing of water quality and other characteristics within the reservoir body of water as well as the other, downstream, body of water for such things as environmental rededication and accidental chemical spills. Up-stream fluid dynamics and thus up-stream ecology can also be affected. The system also allows for the modulation of downstream fluid dynamics and ecology.

The embodiments described herein provide a system which can be installed both in existing reservoirs and dam systems and in newly constructed reservoirs and dam systems having a submerged water intake and outfall system. These embodiments improve the safety of the reservoir and dam and thus benefit the downstream environments affected by the reservoir.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A reservoir withdrawal system, comprising:
a selectively-adjustable water intake positioned within a reservoir, the water intake adapted to withdraw water from the reservoir at a desired depth;
an outfall system in fluid communication with the water intake and with a water outfall; and
a controller to selectively adjust the desired depth of the water intake.

2. The system of claim 1, wherein the water intake is comprised of a telescoping conduit.

3. The system of claim 2, wherein the telescoping conduit is selectively adjustable to regulate the rate of flow of water into the water intake.

4. The system of claim 3, wherein the telescoping conduit is formed of a plurality of telescoping segments, wherein each of the telescoping segments is comprised of an outer conduit and an inner conduit, wherein the outer conduit is comprised of one or more rubber seals to seal water and air in the telescoping conduit.

5. The system of claim 4, wherein the outer conduit rotates around an inner conduit.

6. The system of claim 5, further comprising an air vent to start a siphon.

7. The system of claim 6, wherein the size of the air vent is proportional to the size of the telescoping conduit diameter.

8. The system of claim 3, wherein the water intake includes a filter element to remove contaminants from the water withdrawn from the reservoir.

9. A reservoir withdrawal system, comprising:
a water intake formed at least partially of a telescoping conduit positioned within a reservoir, the water intake adapted to withdraw water from the reservoir at a desired depth;
a siphon-driven outfall system in fluid communication with the water intake and with a water outfall system; and
a controller to selectively adjust the desired depth of the water intake by selectively adjusting the length of the telescoping conduit.

10. The system of claim 9, wherein the telescoping conduit permits an operator to regulate a plurality of water characteristics.

11. The system of claim 10, wherein the plurality of water characteristics are comprised of:
water flow rate, water temperature, water turbidity, and water microbiome.

12. The system of claim 11, wherein the operator utilizes a control module including a user interface to select the plurality of water characteristics.

13. The system of claim 12, wherein the control module is in communication with a sensor array to measure water characteristics.

14. The system of claim 12, wherein the telescoping conduit is formed of a plurality of telescoping segments, wherein each of the telescoping segments is comprised of an outer conduit and an inner conduit, wherein the outer conduit is comprised of one or more rubber seals to seal water and air in the telescoping conduit.

15. The system of claim 13, wherein the length of the telescoping conduit is adjusted by a moving element to extend or retract the telescoping conduit.

16. The system of claim 13, wherein the telescoping conduit is formed of a plurality of telescoping segments, wherein each of the telescoping segments is comprised of an outer conduit and an inner conduit, wherein the outer conduit is comprised of one or more rubber seals to seal water and air in the telescoping conduit.

17. The system of claim 9, wherein the outer conduit rotates around an inner conduit.

18. The system of claim 9, further comprising an air vent to start a siphon.

19. The system of claim 9, wherein the water intake includes a filter element to remove contaminants from the water withdrawn from the reservoir.

20. A selectively-adjustable reservoir water level control system, comprising:
a water intake formed at least partially of a telescoping conduit positioned within a reservoir, the water intake adapted to withdraw water from the reservoir at a desired depth via a controller in communication with a moving element to extend or retract the length of the telescoping conduit;
a siphon-driven outfall system in fluid communication with the water intake and with a water outfall system, the siphon-driven outfall system operating via a selectively-operable air vent in operable communication with the controller; and
a sensor array in operable communication with the controller, the sensor array configured to measure water characteristics to permit the operator to select the depth of the water intake.
